(19) United States
(12) Patent Application Publication
(10) Pub. No.: US 2003/0215065 A1
(43) Pub. Date: Nov. 20, 2003

(54) Method of sending voice messages, and system and server therefor

(76) Inventors: Nicolas Brogne, Buc (FR); Jean-Pierre Kelles, Liege (BE); Emmanuel Sutter, Bonn (FR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/758,245

(22) Filed: Jan. 12, 2001

(30) Foreign Application Priority Data
Jan. 13, 2000 (DE) 10001103.9

(51) Int. Cl. H04M 11/00; H04M 1/64

(52) U.S. Cl. 379/88.13; 379/88.22

(57) ABSTRACT

The present invention relates to a method of sending of voice messages of a caller A to addressees B in a telecommunications network F, and also to a system and a server S therefor.

The telecommunications network has intelligent devices IN that make possible simple integration of a server for handling the voice messages.

In the method, the caller is connected to the server after dialling a certain IN service and transmits to the latter a voice or text message, the desired addressees for said voice message and, optionally, further information for handling the message, for example a time window in which said message is to be sent. The message is then automatically transmitted as voice message to the addressees. The transmission advantageously takes place within a time window specified by the caller.

The invention relates to a method of sending voice messages to telephone subscribers connected to a telecommunications network according to the preamble of the claim 1, and a system and a server therefore.

For some years, the existing telecommunications networks expanded with elements of the so-called “intelligent network” (IN). As a result, various additional services can be offered to the subscribers. Said services are activated by dialling certain numbers. In this process, no subscriber terminals are initially addressed in principle, but special servers belonging to the IN device. The essential requirements for the intelligent network are special digital switching points (SSP=service switching point) that are capable, as a result of additional control programs, of detecting IN calls and passing the requests to a control unit (SCP=service control point). From there on, further IN units, for example servers, referred to in generalized terms also as “intelligent peripherals” (=IP) are activated and user connections are switched to the latter. A survey of the architecture, interfaces and functions of such servers is given in the book entitled “Intelligent Networks” by Gerd Sigmund (ed.) published by Huthig Verlag Heidelberg (ISBN: 3-7785-3908-6) on pages 121-128 under the title “Intelligent Peripheral (IP)”.

In conventional telephone networks, distribution of a voice message to a plurality of addressees is possible only by dialling the addressees consecutively and transmitting the same voice message in each case. In the case of a fairly large number of addressees, this method becomes very cumbersome; in particular, it must always be expected that individual addressees are either away or engaged.

To send fax messages, modern fax machines provide a facility for storing addressees and then dialling them automatically after reading in the fax message. A similar principle would also be conceivable for voice messages; however, this method would have the disadvantage that, on the one hand, a special terminal would be necessary and, on the other hand, the telephone line would be seized for the entire duration of the transmission to all the addressees.

A modern service connected to the Internet offers the possibility of sending e-mails. In this case, messages, usually written documents, can be sent by a sender to selected addressees. This service is very convenient and reliable; however, it has the disadvantage that only owners of an e-mail address can be reached. In addition, Internet subscribers are frequently connected to the Internet only sporadically. An e-mail addressee can, however, read the messages intended for him only if he logs onto the Internet and reviews his “mailbox” for new messages. Furthermore, IN services have been provided in which voice messages of a message provider are stored on a server. Further subscribers who dial a certain IN call number are then connected to this computer and can retrieve the voice message. The switching of callers to said computers may depend, for example, on the call number of a caller, the time and the date. In such a service, however, a message can reach the addressee only if the latter actively calls.

### ADVANTAGES OF THE INVENTION

The object of the invention is to make possible a convenient and substantially automatic method of sending voice messages to selected subscribers without additional terminals or additional devices being necessary at the terminals.

According to the invention, the object is achieved by a method, and also by a system and a server in accordance with the teaching of the independent claims. Further advantageous refinements of the invention are to be found in the dependent claims and the description.

The invention is based on the idea of integrating the method according to the invention into the existing IN architecture in such a way that the service thereby offered can be offered to the telephone subscribers as a further IN service either by the network operator or other service providers.

The invention is explained further below with the aid of the drawings:

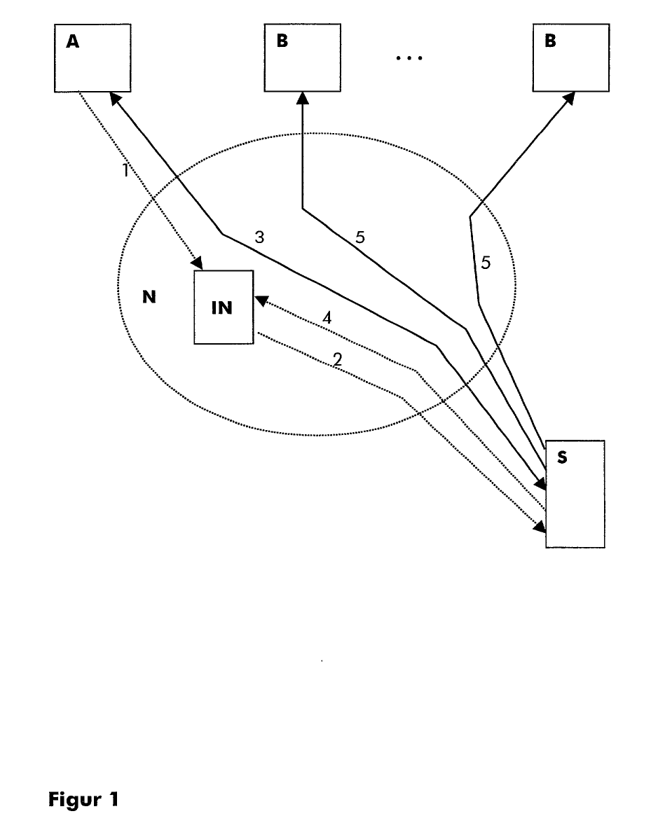

FIG. 1 shows diagrammatically the communication relationships in a telecommunications network with subscriber terminals connected thereto and a server according to the invention.

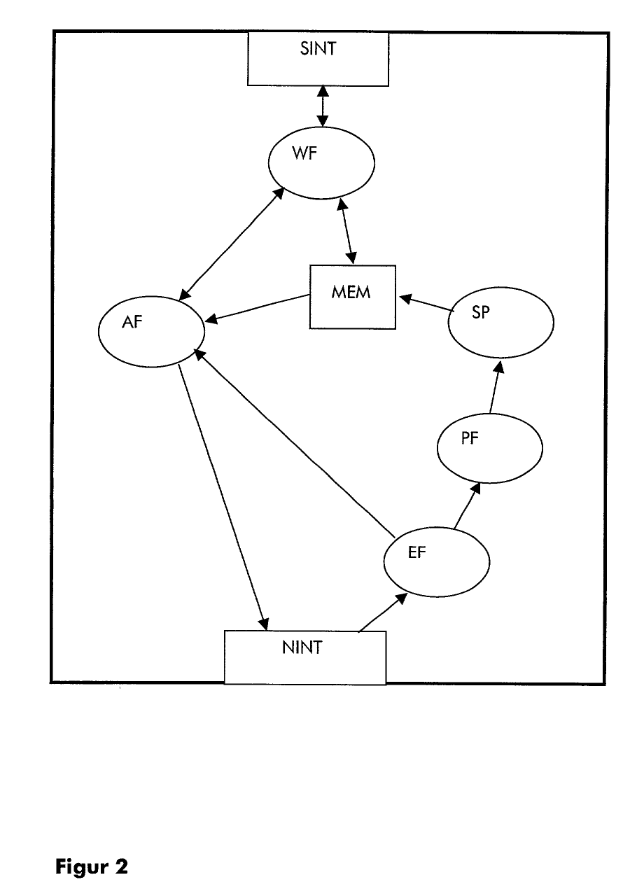

FIG. 2 shows an exemplary embodiment for a function partitioning of a server according to the invention.

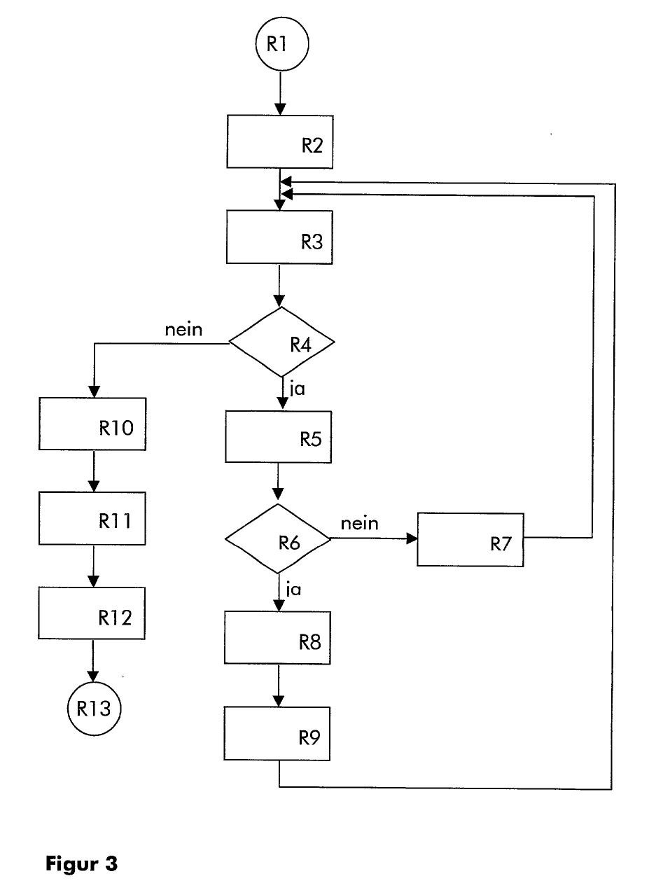

FIG. 3 shows an exemplary embodiment of the first part of a program sequence in a server according to the invention.

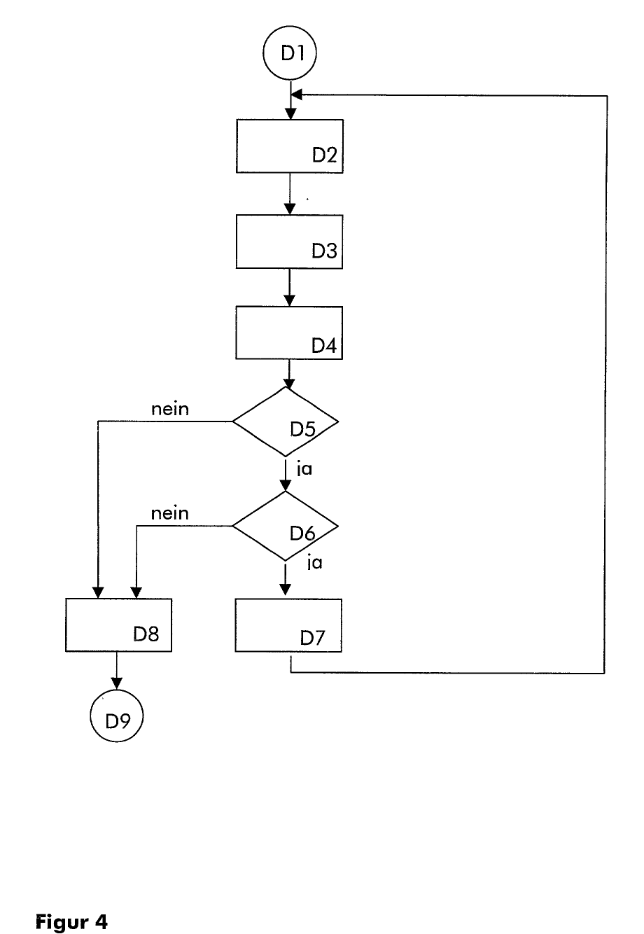

FIG. 4 shows an exemplary embodiment of the second part of a program sequence in a server according to the invention.

FIG. 1 shows the communication relationships 1-5 in a system comprising a telecommunications network N having intelligent network device IN, subscriber terminals A, B connected thereto, A being the service-requiring subscriber and B being the addressee of the service, and a server S according to the invention likewise connected to the telecommunications network N. The essential communication relationships between the said components during the sequence of the method according to the invention are represented by the lines 1-5 and the basic communication direction is represented by arrows. In this diagram, broken lines represent the signalling information and full lines the user communication.

In existing networks, IN architectures are provided in various forms. Thus, the “intelligent peripherals” described above, in particular the server described in claim 11, are incorporated by means of an SSP and/or an SCP. In addition, the server may be provided as an individual computer (e.g. UNIX workstation) or as a multicomputer system comprising a plurality of computers. In this connection, computer architecture, interconnection and function partitioning result in various interfaces between the individual components. The specific partitioning of the IN functions is not important for the present invention. Without restricting the generality, therefore, it will be assumed in the following explanations that the server is provided as an individual, separate computer.

An exemplary embodiment is explained by reference to this figure. The method according to the invention comprises the following steps:

A caller A addresses the IN service according to the invention by dialling a certain IN call number 1.

The IN device (for example, comprising SSP and SCP) detects the call, starts the service according to the invention and informs the server S by transmitting a certain item of information 2.

The IN device initiates the connection of a user connection 3 between the caller A and the server S.

The server S requests the caller A to input the addresses, the voice message and, optionally, to specify the desired transmission time and the desired time window via said user connection 3 by means of a voice output.

After the acceptance of information has been concluded, the user connection 3 is initiated by the server S.

At the desired transmitting time, the server causes the IN device to make the user connections to the desired addressees by transmitting the call number 4. If no desired transmission time has been entered, this initiation takes place immediately after conclusion of the information reception mentioned in the last method step.

After the user connections 5 have been made by the IN device, the voice message is transmitted to the desired addressees.

In the event of failure to reach one or more addressees, the initiation of the making of the connection 4 may be repeated.

By reference to the following figures, a server according to the invention having a function sequence implemented by way of example therein is described by way of example.

FIG. 2 shows by way of example the diagrammatic functional partitioning of a server according to the invention. In this connection, only essential basic functions necessary for the service according to the invention and their interactions are described, i.e. a description, for example, of computer management functions (operating system), is deliberately omitted.

In FIG. 2, it is assumed by way of example that the server S has an interface SINT to a computer (for example, SCP) of the intelligent device IN and an interface NINT to the telecommunications network N for switching user connections to one or more subscribers. The user interface NINT is connected to a voice recognition function EF for incoming messages and to a voice output function AF for outgoing messages. Furthermore connected to the voice recognition function EF is a plausibility function PF for checking the message content; connected to said function is a memory function SF for storing the item of information found to be plausible in a memory MEM. In addition, the memory MEM is connected to the dialling function WF, which accesses the address information (call numbers) and is connected to the IN device of the telephone network via the connection to the signalling interface SINT. The memory MEM, the voice recognition function EF and the signalling interface SINT are connected to the output function AF, which accesses the message stored in the memory MEM and sends it via the connection to the user interface NINT to connected subscriber terminals A, B.

The exemplary sequence of the functions of the server according to the invention is described in two stages. FIG. 3 relates to an exemplary embodiment of the information reception function sequence (first stage):

R1 The information reception sequence is started in FIG. 3 by signalling from the intelligent device IN in the telephone network.

R2 The caller A now connected to the server R is requested by the output function AF to transmit either an address input or the end identifier, for example “end of address input”.

R3 The transmitted information is analysed by the voice detection function EF.

R4 If the information passed by the voice recognition function EF is detected as an end detection, a transfer is made to R10 to receive the voice information. The information is otherwise regarded as address information and the transfer is consequently to R5.

R5 As far as possible, the information is checked by the plausibility function PF for integrity and lack of ambiguity. This is important, in particular, if it is not explicit call numbers, but identifiers previously agreed with the service provider (for example, “parents” or “friends”) that is transmitted for one or more call numbers.

R6 If the plausibility check is passed by the plausibility function, the information is regarded as valid and transferred to R8 for storage. If the plausibility check is a failure, transfer takes place to R7.

R7 The caller is informed via the voice output function AF that the address information is not valid and is requested to make a further input.

R8 The valid call number or valid call numbers are stored by the memory function SP in the memory MEM.

R9 The caller is informed via the voice output function that the address information is valid and is requested to make a further input.

R10 The caller is requested via the output function to transmit the voice message. He is furthermore requested to mark the end of the voice message containing the information with the end identifier, for example “end of voice message”.

R11 The voice message is stored by the memory function SP in the memory MEM.

R12 The caller is informed by the voice output function AF of the end of the acceptance procedure.

R13 The user connection is cleared.

FIG. 4 relates to an exemplary embodiment of the function sequence for passing on information (second stage):

D1 The sequence is started as soon as the sequence described in FIG. 3 is terminated.

D2 The addresses intended for a message are read out of the memory MEM by the dialling function WF and user connections are made to the addressees by transmission to the IN device.

D3 The message is passed to all the addressees to whom it has been possible to make user connections by the output function AF.

D4 The appropriate addresses are erased from the memory MEM by the dialling function WF.

D5 If a certain time, for example a permanently programmed time from the beginning of the sequence, has elapsed (time-out), transfer takes place to D8.

D6 If it was not possible to transmit the message to all the addressees, a transfer is made to D8.

D7 After a certain time, for example a permanently programmed waiting time, a transmission is made to D2 for the purpose of reconnecting to addressees who have not yet been reached.

D8 An acknowledgement is prepared for the caller that he can retrieve. This acknowledgement contains information about addressees of his voice message who have been reached and have not been reached.

In the exemplary embodiments described hitherto, it was assumed that the entire communication occurring between the caller A, the recipient(s) B and the server is composed of voice information. Such an implementation is particularly advantageous since it is, on the one hand, user-friendly and, on the other hand, neither caller nor addressees require special terminals.

In an alternative implementation according to the invention, the addressee input takes place by inputting the appropriate call numbers via the dialling keys of the caller terminal. This information is then analysed in the server by a detection function for detecting the tones generated by dual-tone multifrequency dialling (DTMF).

A further implementation according to the invention provides for the input of the information by Internet communication. In this case, the caller A is connected to the Internet via a PC and a server S. The caller A calls the web page provided by the service operator and preferably designed as a form, fills the latter in with the address information, the message and, optionally, with further items of information and sends the completed web page back to the operator. Said address information is evaluated in the server S, checked for plausibility and stored in the memory MEM in accordance with the exemplary embodiment described above. The voice message likewise stored in the memory MEM is converted into speech by an output function AF (text to speech) and transmitted over the user interface NINT.

As an alternative to this, the message is transmitted not by text input, but by voice input via the microphone of a multimedia PC to the server S.

A particularly advantageous implementation relates to the additional specifying of a desired time window for sending the voice message. This enables the caller to determine the transmission time (start of the time window) of a message. For a certain period (end of the time window), a reconnection is attempted in the event of an addressee not being reached at fixed, periodic intervals. The time window is inputted, analogously to the addressee input in the exemplary embodiment described, with voice prompting. This information is additionally stored in the memory MEM. The message distribution sequence in FIG. 4 is started only when the time window is reached. The time described in step D5 in FIG. 4 (time-out), in the course of which repeated attempts are made to connect to addressees who have not been reached, is the length of the time window for this implementation.

1. Method of sending voice messages to telephone subscribers connected via terminals (A, B) to a telecommunications network (N), which in particular is provided with devices for an intelligent network (IN), wherein a caller, after being connected to a server (S), transmits a voice or text message to said server (S), characterised in that the caller (A) additionally transmits one or more addressees (B) for said message to said server (S), which subsequently initiates the transmission of said message as voice message to said addressee(s)(B).

2. Method according to claim 1, characterized in that the caller (A) transmits the desired sending time of the voice message to the server (S).

3. Method according to claim 1, characterized in that the caller transits a time window in which the connection attempts are to be made.

4. Method according to claim 1, characterized in that the addressees are transmitted by inputting the telephone number.

5. Method according to claim 1, characterized in that the addressees are transmitted by inputting names agreed previously with the service provider for each telephone number.

6. Method according to claim 1, characterized in that the addressees are transmitted by inputting identifiers previously agreed with the service provider for certain subscriber groups.

7. Method according to claim 1, characterized in that the message and/or the addressees are transmitted by means of text input.

8. Method according to claim 1, characterized in that the message and/or addressees are transmitted by means of voice input and a voice recognition is performed in the server (S) to identify the addressees.

9. Method according to claim 1, characterized in that the inputs of the caller are checked in the server (S) for plausibility and lack of ambiguity and the caller is requested to make a repeat input if necessary.

10. System comprising a telecommunications network (N), one or more servers (S) for receiving and delivering voice messages and terminals (A, B), with means:
to receive information of a caller, comprising at least one message and addressees information and
to automatically initiate the transmission of said message as voice message to the terminals (B) of said addressees.

11. Server (S), in particular in conjunction with an intelligent network (IN), that is connected to a telecommunications network (N), having:
an information storage function (SP) to store information from a caller, comprising at least one message and addressees information,
a dialing function (WF) to automatically initiate connections to the addressees (B) and
a voice output function (AF) for generating a voice message to be transmitted to addressees.

12. Server (S), according to claim 11, characterized in that the information storage function (SP) is prepared to store voice information from a caller, and that a voice recognition function (EF) is available to identify the addressees information being part of said voice information.

12. Server (S) according to claim 11, characterized in that it contains a function for storing an information about a desired sending time transmitted by the caller and a function to activate the dialling function (WF) at said time.

13. Server (S) according to claim 11, characterized in that it contains a function, that repeatedly activates the dialling function within a time window until the message has been transmitted to the addressee B.

14. Server (S) according to claim 11, characterized in that it contains a function that stores allocations of designations (names or identifiers) with telephone numbers of said designations.

15. Server (S) according to claim 11, characterized in that it contains a function that checks the transmitted information for plausibility and lack of ambiguity (PF) and requests the caller to make a repeat information input via the voice output function (AF) if necessary.

16. Server (S) according to claim 11, characterized in that it contains means to receive said information sent from an internet terminal of the caller via the internet.
